(19) United States
(12) Patent Application Publication
(10) Pub. No.: US 2015/0134842 A1
(43) Pub. Date: May 14, 2015

(54) TRANSLATED SESSION INFORMATION TO PROVISION A NETWORK PATH

(71) Applicants: Rangaprasad Sampath, Bangalore (IN); Vishal Thapar, Bangalore (IN)

(72) Inventors: Rangaprasad Sampath, Bangalore (IN); Vishal Thapar, Bangalore (IN)

(21) Appl. No.: 14/391,222

(22) PCT Filed: Jun. 25, 2012
(86) PCT No.: PCT/US2012/043932

§ 371 Date: Oct. 8, 2014

(51) Int. Cl. H04L 29/08; H04L 12/24

(52) U.S. Cl. CPC H04L 67/141; H04L 41/12
USPC 709/228

(57) ABSTRACT

A system and method to receive session information corresponding to a session associated with a server, and translate the session information into translated session information including a topology parameter and a data parameter. The translated session information is to direct a controller to provision a network path according to the translated session information. The network path is to be compliant with the topology parameter and data parameter.

### BACKGROUND

Network resources may be allocated to handle various forms of traffic. However, provisioning a network to handle a particular network traffic burden may leave the network overprovisloned and/or underutilized overall. End-to-end Quality of Service (QoS) mechanisms may be used for configuration, but network devices on a network path need manual configuration with appropriate QoS parameters. An OpenFlow controller offers an approach to network configuration, but is not set up to receive configuration instructions from servers/applications attempting to use the network. Thus, an application and/or server may need to use its own built-in network compensation mechanisms to constantly deal with sub-optimal network effects/situations (packet loss, latency, jitter, and other network effects), particularly when the network is to carry other traffic such as voice, data, video, and the like. Such network effects may adversely affect use of the network and impact application performance and user experience, as well as burden application developers with a need to develop various network compensation mechanisms.

### BRIEF DESCRIPTION OF THE DRAWINGS/FIGURES

FIG. 1 is a block diagram of a system including a translation engine according to an example.

FIG. 2 is a time sequence diagram of a system including a translation engine according to an example.

FIG. 3 is a block diagram of a system including a translation engine according to an example.

FIG. 4 is a block diagram of a system including a translation engine according to an example.

FIG. 5 is a flow chart based on translating information according to an example.

### DETAILED DESCRIPTION

A network architecture framework may be provided where a session associated with a server may directly pass network requirements, associated with different phases of the session, to a controller through a Translation Engine (TE). The translation engine may provide a layer of abstraction between the server and the controller, directing the controller to configure (e.g., to provision and/or to deprovision) networks and/or network paths for use by the client and/or server at a per-session and/or per-phase granularity, based on input from the translation engine. The underlying network may carry traffic for a specific server/application (e.g., gaming traffic), along with voice, video, data, email and other forms of network traffic. Typically the network is expansive such that it is impractical to provision the entire network for one particular dedicated usage, so the network may serve as a performance bottleneck manifested as noticeable network effects such as packet loss and latency. By using various example translation engines described herein, users may enjoy a rich immersive experience carried by an underlying network to connect various elements across the network, even when the network is expansive and includes other sources of traffic.

In an example, a translation engine is to receive session information corresponding to a session associated with a server, and translate the session information into translated session information. The translated session information may include a topology parameter and a data parameter. The translated session information is to direct a controller to provision a network path, according to the translated session information, compliant with the topology parameter and data parameter.

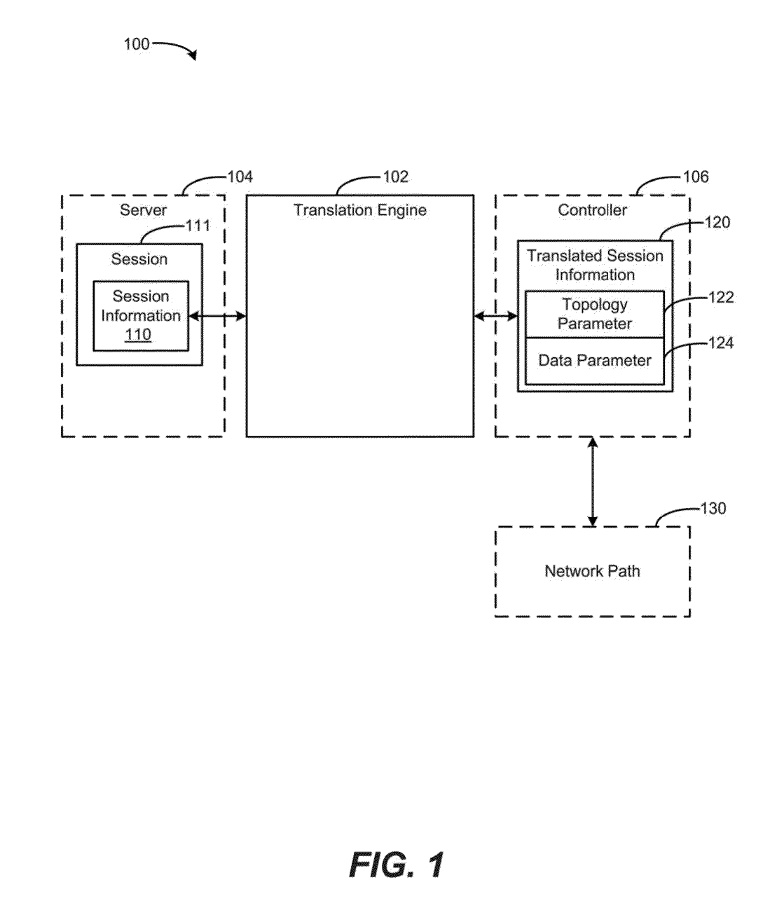

FIG. 1 is a block diagram of a system 100 including a translation engine 102 according to an example. The translation engine 102 may be associated with a server 104 and controller 106 to provide network path 130. The translation engine 102 may receive session information 110 corresponding to session 111 associated with server 104. The translation engine 102 may provide translated session information 120, including a topology parameter 122 and a data parameter 124. The translated session information 120 is usable by controller 106 to affect network path 130.

The server 104 may be associated with various applications, such as cloud storage, virtual networking, data centers, applications with a wide variety of data usage and protocols (e.g., infrastructure of a hotel handling multimedia entertainment, telephone/voice over internet protocol (VOIP), and other data), gaming, and the like. In a hotel infrastructure example, each room may provide an IP phone, internet access for heavy data such as Skype® and video teleconferencing, as well as general web browsing and other uses including a variety of possible protocols and data requirements to support. A usage scenario may include an audio/video conference, watching live streaming video entertainment, and browsing the internet and using a variety of different network requirements, multiplied across the total number of rooms/offices/etc. that are supported by the hotel infrastructure. Different network usage (e.g., phases and/or requirements) may occur simultaneously and one usage may interrupt another. A voice chat may prefer low latency, but streaming video might prefer high throughput that can tolerate lost packets and latency/jitter/packet loss. Benefits provided by system 100 may be particularly advantageous in situations where an available network infrastructure and/or architecture may not be capable of providing a network path 130 to simultaneously meet all the different network requirements that may be associated with various sessions 111 of the server 104.

Network usage, by server 104 and/or a client (not shown in FIG. 1) to interact with server 104, may be based on at least one session 111. A session 111 may be broken down into phases. Network requirements may differ according to the phase and/or session 111, such that a first network path may satisfy the needs of a first phase and/or session 111, but may not necessarily satisfy the needs of a second phase and/or session 111.

The controller 106 may be an OpenFlow controller (see, e.g., OpenFlow Specification 1.0.0 or further revisions). Example systems 100 may interact with an OpenFlow controller without needing any extensions to the standards-based OpenFlow protocol, such that example systems 100 may be compatible with a variety of heterogeneous, multi-vendor networks. Although the server 104, translation engine 102, and controller 106 are shown as separate devices, two or more devices may be co-located within the same device. For example, one physical device may provide functionality of server 104, translation engine 102, and controller 106 based on providing the functionality using programmable software and/or hardware and a processing module based on one or more processors (e.g., one or more central processing units (CPUs)).

The translation engine 102 is to translate session information 110 of the various different sessions 111 into translated session information 120, which may include topology parameter 122, data parameter 124, and/or other information including network requirements that are to be considered when provisioning network path 130. In an example, the topology parameter 122 is associated with network address endpoints that are to be connected, e.g., a network address of a server and client(s). Data parameter 124 may be a requested performance metric, such as a threshold tolerance for latency, data throughput, jitter, lag, and so on. The translation engine 102 (the server 104 and/or the controller 106) may be provided as a software program, a function call, or various other implementations to provide functionality. The translation engine 102 is to send the translated session information 120 to the controller 106.

The controller 106 has access to information associated with a network and its network devices (e.g., its routers, switches, and the like), such that the controller 106 can determine how to connect a path for network devices based on the translated session information 120, such as connecting a client to a server 104, connecting a first host (e.g., server 104) to a second host, and so on. Further, the translated session information 120 provides the controller 106 with an opportunity to determine a suitable and/or best network path for making a connection, e.g., provisioning a network path 130 (and/or deprovisioning or otherwise affecting a network path 130). The controller 106 may affect a network path 130 based on various techniques. For example, based on an OpenFlow controller 106, the controller 106 may program a given network device to make that device part of a network path, based on rules sent by the controller 106 to that network device. Thus, controller 106 may affect a data plane associated with network devices, based on the translated session information 120 provided by the translation engine 102.

Session information 110 may change over time. For example, session 111 may be associated with multiple phases, with session information 110 associated with each phase. Thus, session information 110 may vary for different phases and/or sessions 111, and different information (e.g., data requirements for a given network path 130) may be conveyed to the translation engine 102. The translation engine 102 may translate and/or format the session information 110 to be usable by the controller 106, such that the controller 106 may determine how to implement the translated session information 120 (e.g., by, based on provisioning, updating, deprovisioning, or otherwise affecting network path 130). As the session information 110 changes, the translation engine 102 provides translated session information 120 to enable the controller 106 to change (if appropriate) the implementation of the network path 130 associated with the translated session information 120. The session information 110 may change, e.g., as the session 111 changes between different phases associated with the session 111, enabling the server 104 to communicate with the controller 106 via the translation engine 102, so that the controller 106 may make decisions to improve network usability.

The translation engine 102 may thereby enable network requirements to be handled separately from server application needs, such that a server application does not need to compensate for network effects or other compromises. The translation engine 102 enables use of the network by the server 104 (e.g., by applications associated with the server 104) as an application programming interface (API), such that software components may communicate easily with the controller 106. There is no need for software components to use proprietary extensions or techniques, as system 100 may be based on standards. For example, system 100 may use an OpenFlow controller 106 and the network (including network paths 130) may be based on network devices (routers, switches, and the like) that are compatible with and programmable by an OpenFlow agent. Thus, system 100 (including translation engine 102) may be rolled out on an existing network infrastructure compliant with such standards. This allows application developers to focus on their core competency of writing program and application logic, freed from a need to focus on network compensation techniques built-in to those programs/applications to deal with various network effects.

A given network path 130 may be based on a distributed nature of a network. Each network device, such as a switch/router/etc., may run its own control logic to implement a data plane associated with that network device and its handling of network traffic. The distributed nature may run counter to the idea that there can be one viewpoint to an entire network for easily provisioning an end-to-end path. Thus, distributed networks and their protocols may benefit from providing configuration information tailored to each network device in view of a desired network path 130 and translated session information 120 (or other network requirements for network path 130). Regardless of whether a given configuration can apply to a network device, a need to provision and test each network device provides a challenge of the network's distributed nature that may not provide an overall view on how to configure an entire network. System 100, including translation engine 102, may avoid the impracticalities of needing to manually configure (e.g., configuring quality of service (QoS) requirements using a command-line interface (CLI)) each network device for each phase of each session of each server 104. Thus, system 100 may enable the benefits of a manually tailored network path 130 on a per-phase/session/server basis, without the drawbacks of needing to manually configure each network device. Accordingly, system 100 may overcome roadblocks imposed by scaling limitations associated with manual configurations. For example, it may be overwhelmingly complex to manually configure multiple servers with multiple sessions with multiple phases, while identifying and maintaining which clients are associated with which server/sessions/phases, such that it would be practically impossible to scale using manual CLI programming to implement QoS parameters per device. Examples of system 100 may avoid such scaling limitations, e.g., by providing data abstraction based on translation engine 102 that avoids a need to program each application/program associated with server 104 with knowledge of the particulars on how to “talk” to each network device (switch/router/controller/node etc.) to program the network device to support the various sessions 111.

Another advantage is that intelligence regarding applications, network devices, clients, and the like is sitting on the server-side of system 100. A server 104 may be the best position to capture the information associated with an application and what is needed from the network, due to the visibility the server has regarding what information is needed to be exchanged with clients over the network. Thus, system 100 may be changed (e.g., changing from one application to another) based on making changes to information on the server-side. Accordingly, system 100 does no need to change the client-side, e.g., does not need to push out patches to each client/network device/etc. when changes are made. Changes may be made without burdening clients, such as requiring a client to upgrade or exchange messages between the client/server on the network side of things in response to changes, improving overall efficiency.

In a gaming example, server 104 may be associated with a gaming application having a game session 111 that may include multiple phases. The different phases may be known to the game server, such as a network aware server/application. Phases may be associated with different sets of network requirements, and may include a setup phase, a sync phase, a play phase, and/or a transition phase. Phases may be communicated to the translation engine 102, and the translation engine 102 may translate the phase into one or more network parameters and/or requirements. Multiple clients/users may join a session 111 with the intention to play the game, forming a list of clients during the setup phase. Players may choose a map to play, join/form teams, and/or choose game options such as weapons, etc. during the setup phase. The setup phase may be associated with a heightened throughput requirement for setting up. The sync phase may occur after a setup phase and before a play phase, to synchronize game state and various game parameters among the various players/clients and the game server 104. The sync phase may be associated with high data throughput that will possibly increase with the number of clients signed up to participate in a game session 111. For example, consider the exchange of a custom map that all players will navigate/play on, or the selection of a specific team of players/client that is sent among players/clients from the server 104. Thus, for a sync phase, translation engine 102 may provide translated session information 120 including a data parameter 124 indicating a need for network path 130 to be capable of supporting a high data throughput. The sync phase translated session information 120 may indicate that other considerations, such as latency, are not a priority for that phase. In the play phase, garners play the game. In contrast to the sync phase, the play phase may be associated with several users/clients interacting with each other during the course of the game. During the play phase, low latency may be given priority over data throughput, so that users do not feel the effects of network effects such as jitter/latency/lag that would adversely affect their game performance. Thus, data parameter 124 associated with the play phase may indicate such data requirements accordingly. After a game during the transition phase, all the statistics are shared and the session may be continue or may undergo teardown. The transition phase may denote a termination phase, a phase to join and/or leave an existing session, and/or other various phases included within the term ‘transition phase.’ Network requirements during the transition phase may be normal throughput/latency. A transition may or may not result in a termination. A transition in a gaming context may be that a game session is to be played again such that the session is to be maintained in the instance of the game. The session may be terminated based on a transition phase, such as when at least one player quits and does not play anymore. Such transitions may occur after completing a current game. A transition may or may not lead to a termination. A termination may be associated with not needing the previously provisioned network resources, enabling relinquishment of the resources that have been provisioned for a network path 130.

Phases associated with a session 111, and/or a session 111, may change based on various considerations. An event may trigger an end of one phase/session and the beginning of a different phase/session. However, the same event may be used to trigger a modification of a given phase/session. Thus, examples of system 100 may be associated with different phases/sessions 111, and corresponding session information 110, based on handling of events. Continuing with the gaming example, if there are 8 players, and one player disconnects, the disconnection event may be used to modify and/or end an existing session/phase, and/or begin a different session/phase. The session information 110 may be changed to reflect a different set of needs that the translation engine 102 is to translate into corresponding translated session information 120. In an example, the server 104 may create a new phase/session for the remaining 7 players, including new session information 110 corresponding to the new phase/session 111. The server 104 may maintain the existing game session 111 and modify the session Information 110 to reflect 7 players/clients instead of 8. Thus, the server 104 may react to client-side changes, in addition to server-side changes. A given phase/session 111 may be re-evaluated in response to an event (such as a player quitting). In an example, system 100 may re-evaluate a phase/session and its associated conditions (e.g., clients/players and the game/server state) periodically, and may poll for any changes that may be associated with updating session information 110 for a phase/session 111 (including client-side changes). A transition phase associated with a session 111 may indicate that changes/updates are more likely. A phase/session 111 also may be treated as persistent, regardless of how many clients/players join and/or leave the session, without needing to re-evaluate. Thus, example systems 100 include many different ways of handling phases/sessions 111, including variations in how session persistence is handled. Phases/sessions 111 may be handled on a grouped basis (e.g., all phases associated with a given game, server, and/or client etc.), or on an individual basis, depending on a desired level of granularity and/or control. A session 111 may be network aware such that it may provision network paths 130 according to its need, based on communicating via translation engine 102. A session 111 may be associated with various traffic flows (e.g., a game flow) that also may be associated with the controller 106 and its ability to work with and organize/affect network paths 130.

Accordingly, the translation engine 102 is to translate needs of a session 111 (as expressed. e.g., in session information 110) into information usable by controller 106 to affect a network path 130 suitable for the session (e.g., including multiple different network paths 130 for various phases of a session 111). The server 104 and its associated application/programs are freed from a need to deal with various network effects. Application developers do not need to be concerned about network performance/capacity or how to handle available network resources. For example, the translation engine 102 may provide a layer of abstraction between the server 104 and the controller 106 to enable enhanced usage of available network resources by the server 104, without a need for the server to configure each node associated with a network path 130 and/or without a need for the application to use network compensation mechanisms.

Referring again to the gaming example, a game application may be programmed to include built-in compensation mechanisms to handle network effects such as latency/jitter. For example, when a game encounters excessive latency, a player/client may experience a rubber-banding effect applied to his/her movements and interaction with the game. Such rubber-banding is an example of latency equalization performed by a game application so that each user may participate even with varying degrees of latency between players (e.g., thereby distributing latency handling effects to all players). A downside to such compensation mechanisms is that, depending on the type of compensation, those players with lower latency may have an advantage under one compensation mechanism, but may not have an advantage under another compensation mechanism. Thus, example systems 100 may provide a network path 130 that is to reduce the impact of any latency (or other affects to data parameters 124), such that each client's connection type does not unfairly affect gameplay, and players/clients may avoid the frustration associated with unfairly distributed network effects.

In an example, network compensation mechanisms may still be used, such as triggering the mechanisms (e.g., at the server 104 and/or a client (not shown) in communication with server 104) when the controller 106 determines that available (e.g., provisionable) network paths 130 do not meet every parameter indicated by the translated session information 120. In alternate examples, network compensation mechanisms may be used to enhance performance, even if all parameters requested by a phase/session 111 are capable of being met by at least one network path 130.

Example systems 100 enable network resources to be accessed and used as though accessing an API. For example, a program associated with server 104 may simply request a network requirement such as needing a first level of data throughput and a second level of latency between specified network devices. The program may request confirmation as to whether the controller 106 is able to satisfy the request. If the request is capable of being satisfied (e.g., the controller 106 has identified a network path 130 that may be provisioned/affected consistent with the translated session information 120), the program (e.g., session 111) may proceed. If the controller 106 is unable to provide a network path 130 to satisfy the translated session information 120 (e.g., a network conflict or network data congestion/overload), the controller 106 may inform the translation engine 102 and/or the server 104, so that the application can determine whether to use compensation mechanisms and/or use a network path 130 that does not satisfy all of the parameters associated with the translated session information 120. Thus, compensation mechanisms can be provided on an as-needed basis. Example systems 100 may thereby provide network awareness to applications associated with server 104 and/or translation engine 102. Communication may be monitored/exchanged between the translation engine 102, server 104, controller 106, client, or other parts of system 100 to identify when compensation mechanisms are to be used. System 100 therefore provides freedom for application/game designers to think about the game and not focus on the underlying network that would support the application/game. Example systems 100 may provide benefits to the gaming industry, as well as other industries where various network needs are to be satisfied.

The server 104 will send the session information 110 to the translation engine 102. The session information 110 may include a client list and a session state. A network-aware application/server 104 will know what programs are running and how to communicate the information associated with those programs and how a network might satisfy those resource needs. The translation engine 102 knows what network parameters/requirements might correspond to the given needs, based on the session/phase. For example, the translation engine 102 may identify that a play phase would correspond to a low latency data parameter 124. Thus, an application may provide session information 110 simply identifying a play state, and the translation engine 102 may know to pass translated session information 120 to the controller 106 corresponding to a low latency data parameter 124.

The translation engine 102 may provide various forms of translation, i.e., may respond differently to a given session information 110 depending on the context of the server 104 or particular application. For example, the translation engine 102 may translate a play phase for a first application into a first threshold data parameter 124, while translating the same play phase from a second application into a second threshold data parameter 124. Each application may have different settings as identified by the translation engine 102, which may be customized to tailor translations for each server 104 and/or application/session 111/state. Similarly, the translation engine 102 may identify particular customizations for clients that are to interact with and/or connect to the server 104, enabling customized responses to network clients and even other devices.

The translation engine 102 may be part of controller 106, such as an OpenFlow controller 106 that enables add-on modules that sit on top of the logic for the controller 106. The translation engine 102 may be provided as a separate/stand-alone application, that may be called using a certain API to push specific messages to the controller 106 that are usable by the controller 106. The translation engine 102 may be provided using different techniques, that may depend on what mechanisms the controller 106 is providing. For example, the translation engine 102 may be a software mapping function, program, and/or API. The translation engine 102 can be collocated with the controller 106, can be provided as a separate program, and can be provided as a plug-in to an API of the controller 106. The translation engine 102 may be provided as a software mapping function. Other parts of system 100 (e.g., server 104, controller 106) may be similarly provided and/or combined.

Thus, the server 104 and associated applications do not need to know how to talk to every network device/controller in a network (e.g., along a network path 130), because the translation engine 102 provides an intelligent layer of abstraction to facilitate how server 104 may be compatible with the network and formatting/translating of the session information 110 to be used in setting up each specific controller/node/network device. The translation engine 102 may take needs expressed by the server 104 (e.g., by network aware applications), translate them into network requirements, and convey the network requirements to the controller 106 in a format that the controller 106 can understand and apply toward provisioning network path 130. The translation engine 102 knows how to deal with different types of servers 104, how to understand a way to customize itself to different servers and translate different sessions 111 and/or phases into network requirements that the controller 106 can understand and implement to obtain the needed network resources. The controller 106 knows the network and how to establish a network path 130 between network clients and/or server 104 with support for a given data rate. The controller 106 may use its own techniques (e.g., based on the OpenFlow standard compatible with open source network devices/switches/controllers that include mechanisms to Interact with controller 106) to provision the requested network path 130.

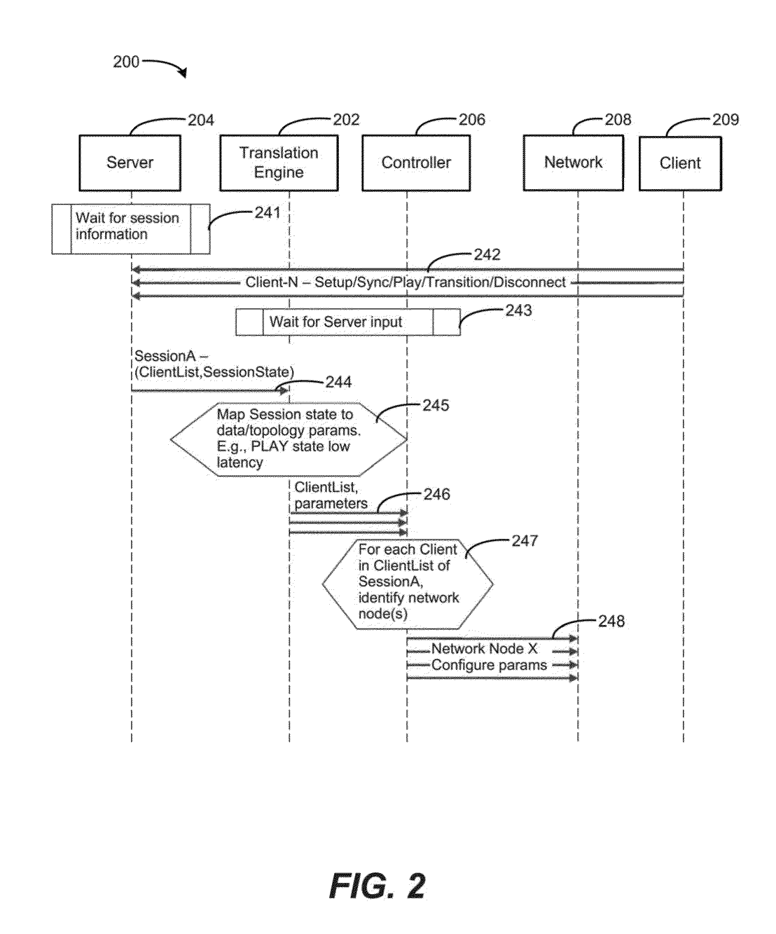

FIG. 2 is a time sequence diagram of a system 200 including a translation engine 202 according to an example. System 200 also may include interactions between at least one server 204, controller 206, network 208, and/or client 209. A server 204 may wait to receive session information, based on a server wait state 241. A client 209 may send client communication 242 to the server 204. The translation engine 202, and/or the controller 206, may wait to receive input from server 204 based on a wait state 243.

System 200 may provide an architecture framework where sessions on the server 204 can directly pass network requirements of different phases of a session to controller 206 through translation engine 202. The translation engine 202 is to provide a layer of abstraction between the server 204 and the controller 206.

In an example, the server 204 can send session information, e.g., (SessionID, ClientList, SessionState), to the translation engine 202 at the beginning of a session. For example, server communication 244 may involve sending the session information. The ClientList (a list of which clients are part of this session) may be sent initially, and may be omitted from being sent in later transmissions for this session as follows. The translation engine 202 may store the mapping of the SessionID to the ClientList. Thus, the server 204 knows the session information, passed to translation engine 202, which translates the session information for each network device/client associated with a given network path. The server 204 may then use the SessionID in subsequent communication to the translation engine 202, thereby omitting the ClientList from subsequent communication. The server 204 may include logic to identify whether the ClientList has already been sent to the translation engine 202 a first time for that session, to enable use of the SessionID in subsequent communications without having to send the ClientList to the translation engine 202 each time. The translation engine 202 may translate the SessionID into the ClientList and use it to identify network endpoints (e.g., client internet protocol (IP) addresses) for each client. The translation engine 202 also may determine network requirements from the SessionState, and then pass the network requirements (e.g., a topology parameter and data parameter) to the controller 206.

Thus, server 204 may provide a list of clients and IP addresses associated with a session. The translation engine 202 may translate the provided session information into information usable by the controller 206, such as topology information including a group of at least two network address endpoints, each pair associated with a quality/data parameter. The translation engine 202 may translate the session information in response to an API call from the server, and the translation engine 202 may use the API layer to pass translated session information to the controller 206. The translation engine 202 may map session information, received from the server 204, to parameters to be passed to the controller, thereby serving as a mapping engine. The translation engine 202 may respond to, and operate as, a function call. In such an example, if the server 204 calls the translation engine 202 as a function and passes parameters (e.g., session information) to the translation engine 202, the translation engine 202 would return translated session information usable by the controller 206. The values returned by the translation engine function call may be passed to the controller 206 based on another API call to the controller 206. In another example, the translation engine 202 may be provided as a networked interface. Session information from the server 204 may be bundled into a network packet, and sent over the network to the translation engine, that could be a complete software program to receive such a packet. The example translation engine 202 can unbundle the packet, translate it for the controller 206, and send to the translated packet to the controller 206. Thus, example translation engines 202 may be provided as full-fledged software packages to receive and manipulate information. The translation engine 202 may be provided as a pure API, or as an API component with software component to it. Examples may be implemented different ways.

When the translation engine 202 receives the client list and IP addresses, it can provide the topology parameter (endpoint addresses) and data parameters for the group. The controller 206 will then understand that, for an example network path from a first client to the server, a data rate of a first threshold is needed. Similarly the controller 206 may understand parameters for additional client(s) and server(s), as appropriate. The translation engine 202 may provide a multiple sets of information to the controller 206, enabling the controller 206 to map out complex network paths while respecting requested network resources/performance for the paths. In the case of multiple clients connected to a single server 204 for a session, the server 204 may provide is a list of clients with their respective IP addresses, along with the server's own IP address. In the case of multiple clients connected via multiple servers 204, each server 204 may provide a list of clients connected to a session running on that server 204, along with the server's own IP address.

Thus, the server 204 may send the server communication 244 to the translation engine 202, such as session information including a session identification, client list, session state, and other information. The translation engine 202 may perform a translation 245, such as mapping session state to data and/or topology parameters. The translation engine 202 may pass a translation engine communication 246, such as a client list and other parameters, to controller 206.

The controller 206 (e.g., an OpenFlow controller) can provision the requisite network path by pushing down rules {Rule: Match, Action} to the various network devices (e.g., a network router/switch) along the network path. Although the server 204, translation engine 202, and controller 206 (and other elements) are shown as separate devices, they may be co-located within the same device (e.g., implemented as software programs executable by a processor).

The controller 206 may perform a controller activity 247, such as identifying network node(s) for each client in the client list associated with a session. The controller 206 may send a controller communication 248, such as configuration parameters for a network node, to the network 208. For example, a controller communication 248 may be sent to each network node on a network path, as identified by the translation engine 202, the network path being associated with at least one client 209 and/or server 204 of at least one network 208.

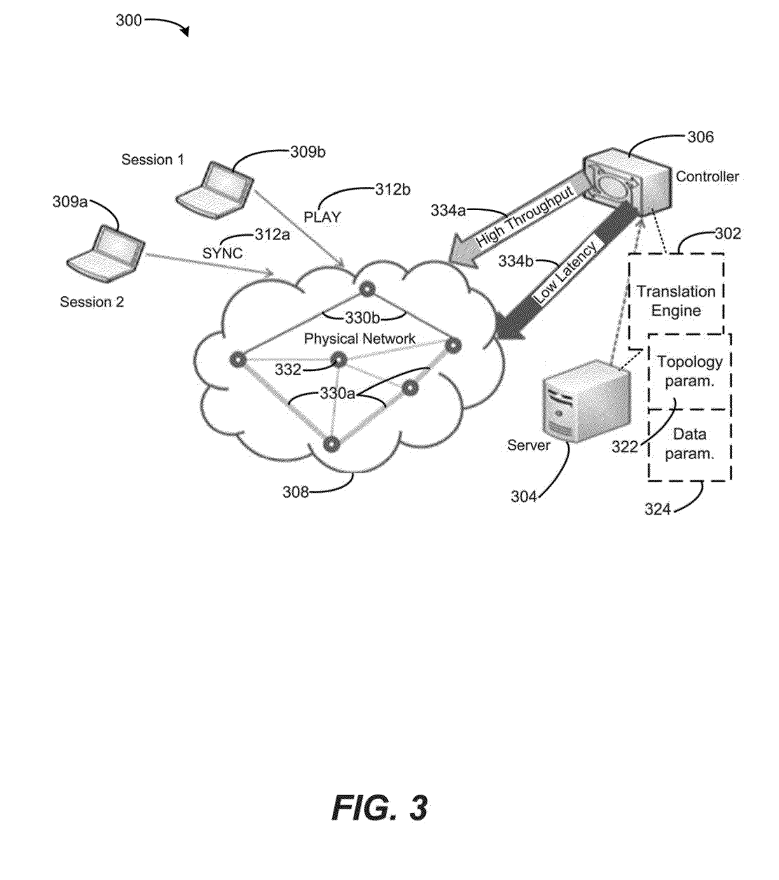

FIG. 3 is a block diagram of a system 300 including a translation engine 302 according to an example. The translation engine 302 may be associated with a server 304 and/or a controller 306, to manage usage of network 308 by first client 309a, second client 309b, and/or server 304. A client may be associated with at least one phase, such as a first phase 312a (e.g., sync) and a second phase 312b (e.g., play). The translation engine 302 may interact with server 304 and/or controller 306 based on a topology parameter 322 and a data parameter 324. System 300 may include additional network nodes 332 and/or network paths 330 beyond those specifically shown.

The controller 306 may interact with the network 308 based on at least one flow, such as first flow 334a (e.g., high throughput), and/or second flow 334b (e.g., low latency). At least one flow may be associated with at least one phase 312 and/or session. The network 308 may include at least one network node 332 and network path, such as first network path 330a and second network path 330b.

As illustrated, the translation engine 302 may provide first topology parameter 322 and data parameter 324 corresponding to the first phase 312a. The controller 306 establishes first path 330a to provide the high throughput associated with the first phase 312a (sync), based on corresponding network nodes as configured by the controller 306 in response to the translated session information (first topology parameter 322 and data parameter 324) provided by the translation engine 302. Similarly, the translation engine 302 may provide second translated session information (second topology parameter 322 and data parameter 324) for the controller to establish a low latency second network path 330b corresponding to the second phase 312b (play). Thus, a first client 309a may utilize a high throughput path when in a phase (sync) that takes advantage of high throughput, and a second client 309b may utilize a low latency path when in a phase (play) that takes advantage of low latency. Multiple different clients may use different phases/paths throughout a given session.

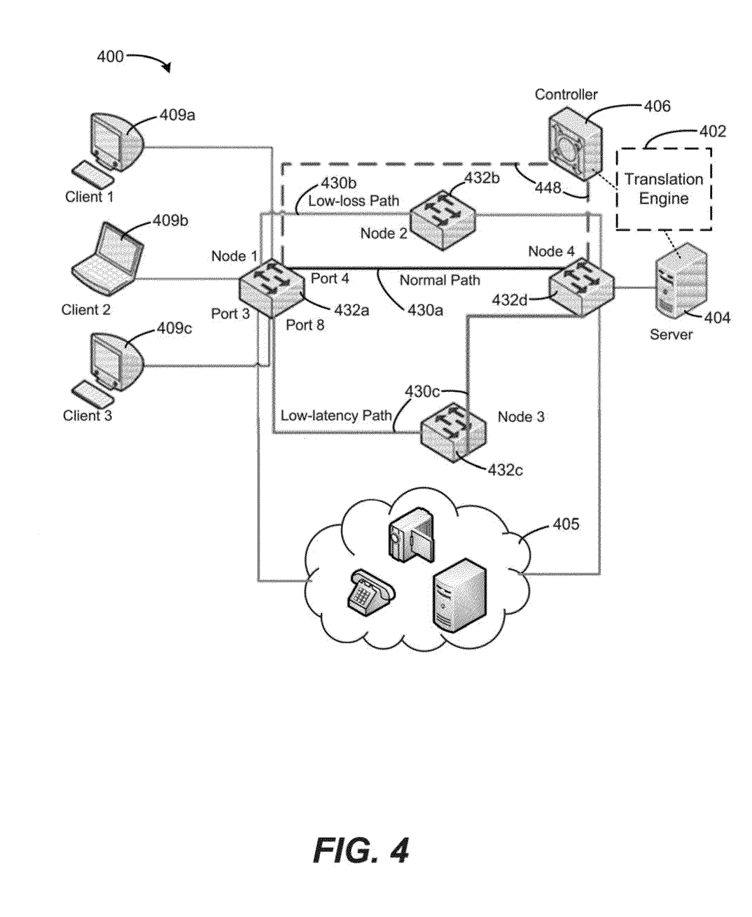

FIG. 4 is a block diagram of a system 400 including a translation engine 402 according to an example. The translation engine 402 may be associated with server 404 and/or controller 406. Communication may pass from translation engine 402, server 404, and/or controller 406 over the network to first client 409a, second client 409b, and/or third client 409c. Network communication may be based on at least one network node, such as first network node 432a, second network node 432b, third network node 432c, and/or fourth network node 432d, and at least one network path, such as first network path 430a, second network path 430b, and/or third network path 430c. Communication may be provided in view of other traffic 405, such as telephony, video/multimedia, and other traffic sources/destinations associated with the network. Additional nodes/paths and other elements may be provided, beyond than those specifically shown.

Each path between endpoints may involve various network devices, such as nodes 432a-432d. In an example, a network node is network switch such as a router that can make forwarding decisions as to networking traffic passing through that network node. The router is to know how to send packets (i.e., network traffic) after they have been received at the router. Decision logic of where to send packets may be within the particular network node 432a-432d, and the network nodes 432a-432d may run protocols that are compatible with control standards such as OpenFlow protocol. A network node may receive a packet, and send it out according to the rule pushed down to the network node by the controller 406. The logic of how to route packets on a per-network node basis may be housed remotely at the controller 406 (and/or the translation engine 402 or server 404).

The architecture can carry data while also carrying voice, video, general data, and other network traffic 405. Three clients 409a. 409b, and 409c are shown, to be connected to server 404 (e.g., to play a game on the network). The voice, video and data traffic 405 carried by the network also is to be passed through at least one of the network nodes 432a-432d. Thus, the various network nodes 432a-432d must deal with being burdened by the additional traffic 405, without negatively affecting the connection shared by the clients 409a-409c and the server 404.

As the clients 409a-409c connect and the session progresses through various phases, the server 404 and the controller 406 can communicate with each other to pass network requirements and other information via the translation engine 402. In a gaming example, in a play phase, the game server 404 may pass on a list of clients 409a-409c, the game server ID and the maximum allowed latency requirement of this play phase. OpenFlow controller 406 that is aware of the network topology can carve out a network path (e.g., network path 430c associated with low latency) for the play phase by programming OpenFlow rules on the various network devices/nodes 432a-432d that connect the game clients 409a-409c to the game server 404. The rules are sent down by the OpenFlow controller 404, and stored on the switches/nodes 432a-432d (e.g., passing rules from the control plane on the server side/controller 406, to the data plane elements/nodes 432a-432d). The controller 406 may implement control techniques that affect fewer than all of the nodes 432a-432d, e.g., the controller 406 may create a path based on one node 432.

A node 432 may be programmed based on rules, such as match/act pairs, implemented on each node 432. Table 1 shows an example for node 1, e.g., node 432a. A packet received at node 432a may be checked for a destination IP address according to the match criteria of the first row. If the destination IP matches, the action to be taken is sending the received packet out of port 8 of node 432a. According to the second row match, if a packet is received inbound from port 3 of node 432a, that packet is sent outbound out of port 4 of node 432a. Thus, a rules-based match/action may be programmed into each switch/node 432, based on how OpenFlow standards define each rule as pushed out by the controller 406 for translated session information from the translation engine 402.

TABLE 1

| Match | Act |
|---|---|
| Node 1: Dst. IP == Game Server IP | Node 1: Out Port = 8 |
| address | |
| Node 1: In port == Port 3 | Node 1: Out Port = 4 |

In other words, the rules in Table 1 imply that Node 1 (node 432a), upon receiving any IP traffic destined for the game server 404, will send out that traffic via Port 8 which has been selected by the OpenFlow controller 406 as a low latency path 430c from the game clients 409a-409c to the game server 404. Traffic that is not destined to the game server 404 will continue using the normal path i.e. outbound Port 4 in this case per the Act shown in the second row of Table 1.

The example shown in FIG. 4 is to send down rules according to Table 1. All traffic destined for the address of the game server 404 is to be switched out of a certain port that is identified by the controller 406 as being on a path conducive for communicating with the server 404. i.e., gaming, according to the data parameter and topology parameter as indicated by the translation engine 402. All other traffic may be switched out of a different port of the node 432a, thereby giving priority to gaming traffic based on the chosen path through the chosen port that is known to support the desired data parameter. The example shown may be expanded to include an arbitrary number of clients 409, nodes 432, servers 404, and/or other elements.

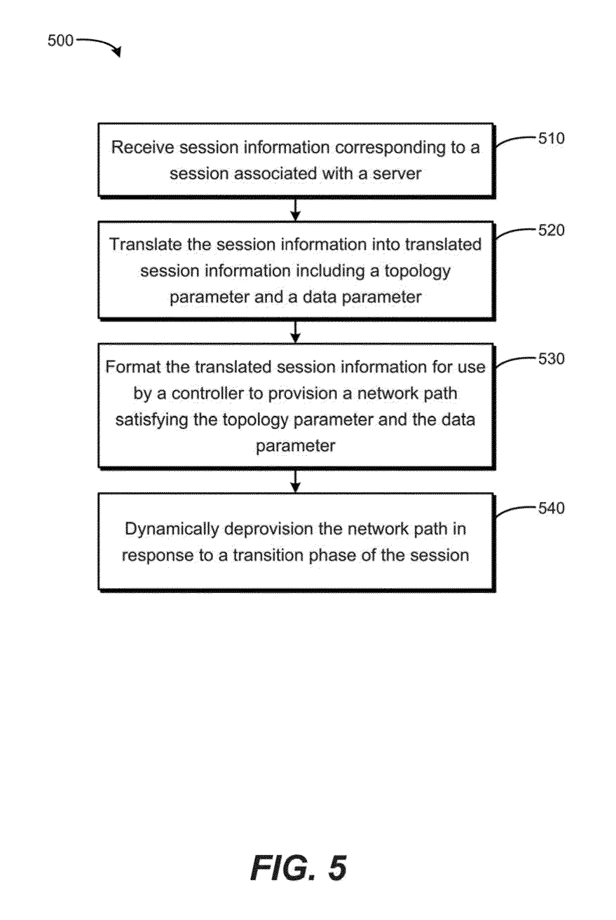

FIG. 5 is a flow chart 500 based on translating information according to an example. In block 510, session information corresponding to a session associated with a server is received. For example, a server may send information regarding what is needed by an application associated with the server. In block 520, the session information is translated into translated session information including a topology parameter and a data parameter. For example, the translation can take the needs expressed by the server, and convert that into a form that expresses a network endpoints (topology parameter) to be connected, and a target level of service (data parameter) to be provided between those endpoints. This may be repeated multiple times to support an arbitrary number of endpoints/paths. In block 530, the translated session information is formatted for use by a controller to provision a network path satisfying the topology parameter and the data parameter. For example, the information may be formatted in the form compatible with an OpenFlow controller. In block 540, the network path may be dynamically deprovisioned in response to a transition phase of the session. For example, the dynamic deprovisioning may be associated with a termination phase (e.g., the termination phase may be a type of transition phase). In alternate examples, a session may persist, and the network path may be persisted for use in other phases/sessions.

Examples can be implemented in hardware, software, or a combination of both. Example systems can include a processor and memory resources for executing instructions stored in a tangible non-transitory medium (e.g., volatile memory, non-volatile memory, and/or computer readable media). Non-transitory computer-readable medium can be tangible and have computer-readable instructions stored thereon that are executable by a processor to implement examples according to the present disclosure.

An example system (e.g., a computing device) can include and/or receive a tangible non-transitory computer-readable medium storing a set of computer-readable instructions (e.g., software). As used herein, the processor can include one or a plurality of processors such as in a parallel processing system. The memory can include memory addressable by the processor for execution of computer readable instructions. The computer readable medium can include volatile and/or non-volatile memory such as a random access memory (“RAM”), magnetic memory such as a hard disk, floppy disk, and/or tape memory, a solid state drive (“SSD”), flash memory, phase change memory, and so on.

Examples enable a centralized approach to provisioning network resources per application/session/phase, e.g., addressing game needs in conjunction with a controller. Example architectural frameworks enable applications, such as games, to operate without focusing on compensating for network effects like packet loss, latency and jitter. Examples enable game designers to focus on the game and not on the underlying network that may support that game. Examples do not require particular extensions to standards such as the OpenFlow protocol, thus guaranteeing that examples are compatible with heterogeneous, multi-vendor networks.

What is claimed is:

1. A method, comprising:
receiving, at a translation engine, session information corresponding to a session associated with a server;
translating the session information into translated session information including a topology parameter and a data parameter; and
formatting the translated session information for use by a controller to provision a network path satisfying the topology parameter and the data parameter.

2. The method of claim 1, wherein a first phase of the session is associated with first session information including a high throughput data parameter, and a second phase of the session is associated with second session information including a low latency data parameter.

3. The method of claim 1, wherein a first phase of the session is associated with a first network path satisfying the topology parameter, and a second phase of the session is associated with a second network path satisfying the topology parameter.

4. The method of claim 1, further comprising dynamically deprovisioning the network path in response to a transition phase of the session.

5. The method of claim 1, wherein the session information includes at least one of a session ID, a client list, and a session state.

6. The method of claim 1, wherein the topology parameter includes a first network address corresponding to a first endpoint of the network path, and a second network address corresponding to a second endpoint of the network path.

7. The method of claim 1, wherein the data parameter includes a data requirement associated with at least one of latency, throughput, jitter, and packet loss.

8. A translation engine to:
receive session information corresponding to a session associated with a server;
translate the session information into translated session information including a topology parameter and a data parameter; and
direct a controller to provision a network path, according to the translated session information, compliant with the topology parameter and data parameter.

9. The translation engine of claim 8, wherein the translation engine is associated with an application programming interface (API) call.

10. The translation engine of claim 8, wherein the translation engine includes mapping information to map a session ID, included in the session information, to a client list including a list of network clients associated with the session; and the translation engine is to identify at least one network endpoint for each of the network clients based on the mapping information.

11. The translation engine of claim 8, wherein the controller is an OpenFlow controller, and the translated session information is to direct the OpenFlow controller to dynamically provision a network path according to a flow associated with the OpenFlow controller.

12. The translation engine of claim 8, wherein the translation engine is to direct the controller to provision a substitute network path in response to the network path being noncompliant with a service level associated with the data parameter.

13. The translation engine of claim 8, wherein the translation engine is to direct the server to trigger a compensation mechanism at the server in response to the network path being noncompliant with a service level associated with the data parameter.

14. A tangible, non-transitory computer-readable medium storing a set of instructions that, when executed by a processor, perform a method to:
receive session information corresponding to a session associated with a server;
translate the session information into translated session information including a topology parameter and a data parameter; and
format the translated session information for use by a controller to provision a network path satisfying the topology parameter and the data parameter.

15. The computer-readable medium of claim 14, further comprising instructions to translate the session information based on server translation information corresponding to the server.
